(19) United States
(12) Patent Application Publication
(10) Pub. No.: US 2004/0167309 A1
(43) Pub. Date: Aug. 26, 2004

(54) Vinyl-polymerizable monomer having tertiary hydroxyl group and polymer

(76) Inventors: Nobuya Saegusa, Kanagawa (JP); Akihiro Honma, Kanagawa (JP); Hajime Yamada, Kanagawa (JP); Takamasa Kawashima, Kanagawa (JP); Shojiro Kuwahara, Kanagawa (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/788,388

(22) Filed: Mar. 1, 2004

Related U.S. Application Data
(62) Division of application No. 10/122,191, filed on Apr. 16, 2002, now abandoned.

(30) Foreign Application Priority Data
Apr. 26, 2001 (JP) 2001-129047
Oct. 17, 2001 (JP) 2001-319113
Oct. 17, 2001 (JP) 2001-319117

(51) Int. Cl. C08F 20/26

(52) U.S. Cl. 526/318.42

(57) ABSTRACT

The monomer of the present invention is represented by the following Formula 1:

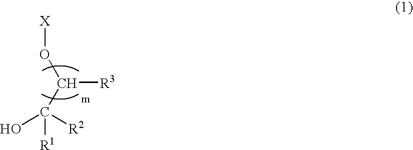

wherein X, R¹ to R³, and m are as defined in the disclosure. The monomer is structurally characterized by the presence of a tertiary hydroxyl group and a vinyl-polymerizable group X and the absence of an ester linkage derived from a tertiary hydroxyl group. Polymers produced by the polymerization of the monomer and an optional comonomer have a moderated reactivity and hydrophilicity.

### BACKGROUND OF THE INVENTION

1. Field of the Invention

The present invention relates to a novel vinyl-polymerizable monomer having a tertiary hydroxyl group and a vinyl-polymerizable functional group and a production method of the monomer. The present invention is also relates to a novel functional polymer having a tertiary hydroxyl group, which is produced by the polymerization of the monomer alone or the copolymerization of the monomer with various vinyl comonomers.

Because of having the tertiary hydroxyl group, the novel functional polymer simultaneously has a moderate reactivity and hydrophilicity, and therefore, the water content of its hydrogel can be regulated as desired by controlling the content of the tertiary hydroxyl group. The polymer is useful as a medical material because the hydrophilicity of its surface can be easily controlled. The polymer is also useful as a polyol component of a paint, because the pot-life of the paint can be regulated as desired and the rate of the hardening reaction of a paint can be controlled by controlling the content of the tertiary hydroxyl group, thereby providing a paint film with a smooth surface.

2. Description of the Prior Art

It has been conventionally known that the hydrophilicity of a polymer can be improved by polymerizing a vinyl-polymerizable monomer having a hydroxyl group to introduce hydroxyl groups to polymer side chains. By reacting with the introduced hydroxyl groups, various types of other functional groups can be introduced. For example, a copolymer of a monomer having a primary hydroxyl group such as 2-hydroxyethyl methacrylate and a copolymer of a monomer having a secondary hydroxyl group such as 2-hydroxypropyl methacrylate have been widely used as a paint material and a medical material by utilizing their hydrophilicity and reactivity due to the primary or secondary hydroxyl group.

A polymer having a primary or secondary hydroxyl group, however, may cause problems due to the high reactivity of the hydroxyl group. For example, a polyurethane paint has been widely used as a two package paint comprising a main component including a coating resin and a hardener including polyisocyanate, which are mixed with each other just before its use. Because of an extremely high reactivity of the isocyanate groups of the hardener, the isocyanate groups rapidly react with the primary or secondary hydroxyl groups of the coating resin after mixing the main component and the hardener, thereby causing a problem of a short pot-life (usable life).

A highly hydrophilic homopolymer is water-soluble and water-swelling. Therefore, for the use in an aqueous condition, a copolymerization of a hydrophobic monomer is practically necessary. To improve the hydrophilicity, a polymer is required to have a large number of hydrophilic groups. The polymer, however, becomes soluble or swelling as the number of the primary or secondary hydroxyl groups increases to cause problems such as a dissolution of the polymer into a contacting aqueous medium, a poor appearance of a coating film surface, and a lowered mechanical strength of a coating film. Thus, no sufficient performance is obtained in the use under an aqueous condition.

As a vinyl-polymerizable compound having a tertiary hydroxyl group, pinacol derivatives are known from old. In addition, Japanese Patent Publication No. 7-061980, etc. disclose monoesters of hydroxyadamantane. However, the proposed compounds are expensive and poor in the heat stability and the resistance to hydrolysis because of the presence of an ester linkage derived from a tertiary hydroxyl group, thereby largely limiting their application. Although a high heat resistance and a high refractive index attributable to the adamantane structure are recognized, nothing is reported up to the present on the properties attributable to the tertiary hydroxyl group.

### SUMMARY OF THE INVENTION

An object of the present invention is to provide a novel vinyl-polymerizable monomer that imparts a moderate reactivity and hydrophilicity to a polymer, thereby solving the problems mentioned above.

The inventors have found that a vinyl polymer produced by polymerizing a novel vinyl-polymerizable monomer having a tertiary hydroxyl group has a moderate reactivity and hydrophilicity, and have accomplished the invention based on this finding.

Thus, the present invention relates to a novel vinyl-polymerizable monomer having a vinyl-polymerizable group and a tertiary hydroxyl group, which is represented by the following Formula 1:

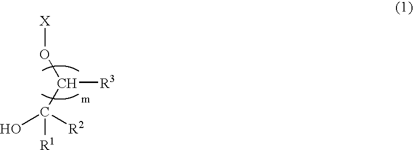

wherein X is a vinyl-polymerizable group; R¹ and R² may be the same or different and are each an alkyl group having 1 to 4 carbon atoms; and R³ is methyl or hydrogen, m is an integer of 1 to 3; with the proviso that two or three R³ groups when m is 2 or 3 are the same or different from each other.

The vinyl-polymerizable group X is preferably represented by the following Formula 2:

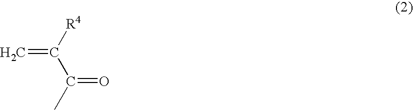

wherein R⁴ is methyl or hydrogen. Preferred are vinyl-polymerizable monomers represented by the following Formulas 3, 4 and 5:

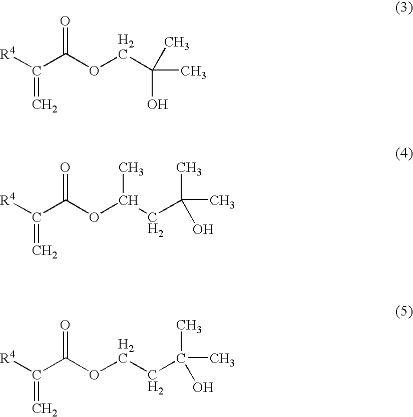

wherein R⁴ is the same as defined above.

The present invention also relates to a production method of the novel vinyl-polymerizable monomer.

The present invention further relates to a polymer having tertiary hydroxyl groups, which is produced by the polymerization of the vinyl-polymerizable monomer of Formula 1 alone or with a comonomer.

The present invention still further relates to a medical material having its surface made of the above polymer.

The present invention still further relates to a coating resin comprising the above polymer.

### BRIEF DESCRIPTION OF THE DRAWINGS

FIG. 1 is a chart for showing ¹H-NMR spectra of the vinyl-polymerizable monomer prepared in Example 1;

FIG. 2 is a chart for showing ¹³C-NMR spectra of the vinyl-polymerizable monomer prepared in Example 1;

FIG. 3 is a chart for showing ¹H-NMR spectra of the vinyl-polymerizable monomer prepared in Example 3;

FIG. 4 is a chart for showing ¹³C-NMR spectra of the vinyl-polymerizable monomer prepared in Example 3;

FIG. 5 is a chart for showing ¹H-NMR spectra of the vinyl-polymerizable monomer prepared in Example 5;

FIG. 6 is a chart for showing ¹³-NMR spectra of the vinyl-polymerizable monomer prepared in Example 5;

FIG. 7 is a chart for showing ¹H-NMR spectra of the vinyl-polymerizable monomer prepared in Example 6;

FIG. 8 is a chart for showing ¹³C-NMR spectra of the vinyl-polymerizable monomer prepared in Example 6;

FIG. 9 is a chart for showing ¹H-NMR spectra of the vinyl-polymerizable monomer prepared in Example 7;

FIG. 10 is a chart for showing ¹³C-NMR spectra of the vinyl-polymerizable monomer prepared in Example 7;

FIG. 11 is a chart for showing ¹H-NMR spectra of the vinyl-polymerizable monomer prepared in Example 8; and

FIG. 12 is a chart for showing ¹³C-NMR spectra of the vinyl-polymerizable monomer prepared in Example 8.

### DETAILED DESCRIPTION OF THE INVENTION

The vinyl-polymerizable monomer of the present invention is structurally characterized by:

(1) having at least one tertiary hydroxyl group;

(2) having at least one vinyl-polymerizable group; and

(3) having no ester linkage derived from a tertiary hydroxyl group.

The vinyl-polymerizable monomer is synthesized by the reaction of a starting compound A for introducing the vinyl-polymerizable group and a starting compound B for introducing the tertiary hydroxyl group. The bonding residue of the starting compound A constitutes the vinyl-polymerizable group X.

The starting compound A and the starting compound B may be bonded through an ester linkage, an ether linkage, an acid anhydride linkage, an urethane linkage, etc., with the ester linkage being preferred in view of easiness of reaction.

As the starting compound A, a vinyl-polymerizable compound is usable. Various types of vinyl-polymerizable compounds such as unsaturated carboxylic acid derivatives, styrene derivatives, vinyl ethers, and allyl compounds are converted into the monomer having a tertiary hydroxyl group as far as having a reactive functional group such as hydroxyl group, ester group and carboxyl group. In view of polymerizability and easy availability, the unsaturated carboxylic acid and its ester are preferably used.

Examples of the unsaturated carboxylic acid include an aliphatic monocarboxylic acid such as acrylic acid, methacrylic acid, crotonic acid and trifluoromethylacrylic acid; an aliphatic dicarboxylic acid such as maleic acid, fumaric acid, itaconic acid and citraconic acid; and an aromatic unsaturated carboxylic acid such as cinnamic acid. These acid may be used in the form of halide. In view of easy availability and high reactivity, acrylic acid and methacrylic acid are preferred. In the present invention, acrylic acid and methacrylic acid are collectively referred to as “(meth)acrylic acid.”

Examples of the ester of unsaturated carboxylic acid include an aliphatic monocarboxylate such as acrylic ester, methacrylic ester, crotonic ester and trifluoromethylacrylic ester; an aliphatic dicarboxylate such as maleic ester, fumaric ester, itaconic ester and citraconic ester; and an aromatic unsaturated carboxylate such as cinnamic ester. In view of easy availability and high reactivity, the acrylic ester and the methacrylic ester are preferably used.

In addition, an unsaturated isocyanate compound such as 2-isocyanatoethyl methacrylate and methacryloylisocyanate may be used as the starting compound A.

As the starting compound B, i.e., the other starting compound for producing the monomer, usable are a polyhydric alcohol having a primary or secondary hydroxyl group in addition to a tertiary hydroxyl group and isobutylene oxide.

Examples of the polyhydric alcohol include 2-methyl-1,2-propanediol, 2-methyl-1,2-butanediol, 2-methyl-2,3-butanediol, 3-methyl-1,3-butanediol, 2,3-dimethyl-1,2-butanediol, 2,3-dimethyl-1,3-butanediol, 2-methyl-1,2-pentanediol, 3-methyl-1,3-pentanediol, 4-methyl-1,4-pentanediol, 2-methyl-2,3-pentanediol, 2-methyl-2,4-pentanediol, 2-ethyl-1,2-butanediol, and 1,4-dihydroxy-1-methylcyclohexane. Optical isomers, if any, may be used singly or in the form of a racemic mixture. In view of easy availability, 2-methyl-1,2-propanediol (isobutylene glycol), 2-methyl-2,4-pentanediol (hexylene glycol), and 3-methyl-1,3-butanediol are particularly preferred.

In case of using isobutylene oxide as the starting compound B, the compound of Formula 1 can be obtained by directly reacting isobutylene oxide with the starting compound A by a ring-opening addition reaction. Alternatively, an alkylene oxide such as ethylene oxide and propylene oxide is first reacted with the starting compound A by a ring-opening addition reaction, followed by the addition of isobutylene oxide at the termination stage of the ring-opening addition reaction.

The reaction to bond the starting compound A to the starting compound B is carried out in the presence of a catalyst that can be selected from various types of compounds. In case of using (meth)acrylic acid or (meth)acrylic ester as the starting compound A to carry out the reaction by esterification or ester interchange, examples of the catalysts include, but not limited to, a metal such as alkali metals, alkaline earth metals, aluminum, tin, zinc, lead, titanium, bismuth, zirconium, germanium, cobalt, chromium, iron, and copper; a compound of the preceding metal such as organometallic compounds, salts of organic acids, salts of inorganic acids, halides and hydroxides; an organic sulfonic acid; and a solid acid such as sodium methoxide, lithium methoxide, sodium aluminate, cationic ion-exchange resins, zeolites, silica-alumina, silica-titania, bentonite, montmorillonite, and activated clay. In case of using (meth)acryloyl halide as the starting compound A to carry out the reaction by esterification, usable as the catalyst are a tertiary amine and an inorganic base such as triethylamine, tripropylamine, N,N-diisopropylethylamine, tributylamine, trioctylamine, pyridine, 4-dimethylaminopyridine, 4-pyrrolidinopyridine, sodium hydroxide, potassium hydroxide, sodium carbonate, sodium hydrogencarbonate, potassium carbonate, and potassium hydrogencarbonate.

The temperature for each reaction in the presence of the above catalyst should be suitably selected. In case of using (meth)acrylic acid or (meth)acrylic ester as the starting compound A to carry out the reaction by esterification or ester interchange, the reaction is carried out at 40 to 250° C., preferably 50 to 150° C. while removing alcohol and water being generated. The reaction pressure may be atmospheric, or above or below atmospheric pressure. The reaction is preferably carried out at atmospheric pressure or lower as the reaction-proceeds, more preferably at 300 mmHg or lower. To facilitate the removal of alcohol and water being generated, an azeotropic solvent may be present in the reaction system. In case of using (meth)acryloyl halide as the starting compound A to carry out the reaction by esterification, the reaction is carried out at −20 to 90° C., preferably 0 to 60° C. The reaction fails to proceed sufficiently at lower than −20° C. A temperature exceeding 90° C. is unfavorable because side reactions such as polymerization are likely to occur.

The method of the present invention for producing the vinyl-polymerizable monomer having a tertiary hydroxyl group may include a step for ring-opening a cyclic ester or a cyclic dimer of oxyacid. The ring-opening reaction is carried out at 40 to 250° C., preferably 80 to 150° C. optionally in the presence of the catalyst mentioned above.

The vinyl-polymerizable monomer having a tertiary hydroxyl group is easily polymerized alone or copolymerized with various vinyl comonomers by a known polymerization method such as radical polymerization, anionic polymerization and anionic coordination polymerization.

The copolymerizable vinyl comonomer may be selected from unsaturated carboxylic acids, their esters, styrene, styrene derivatives, conjugated vinyl compounds and α-olefins. The type and the amount of the comonomer are suitably selected depending on the intended use of resultant polymer. The comonomers may be used alone or in combination of two or more. Examples of the comonomer include (meth)acrylates such as methyl(meth)acrylate, ethyl(meth)acrylate, butyl(meth)acrylate, stearyl(meth)acrylate, cyclohexyl(meth)acrylate, isobornyl(meth)acrylate, 2-methoxyethyl(meth)acrylate, 2-ethoxylethyl(meth)acrylate, 2-hydroxyethyl(meth)acrylate, and 2-hydroxypropyl(meth)acrylate; (meth)acrylates having a phospholipid-like functional group such as 2-(meth)acryloyloxyethyl phosphorylcholine; aromatic vinyl compounds such as styrene, a-methylstyrene and chlorostyrene; vinyl compounds such as acrylonitrile, methacrylonitrile, acrolein and methacrolein; α-olefins such as ethylene and propylene; N-substituted maleimides such as N-methylmaleimide, N-phenylmaleimide and N-cyclohexylmaleimide; acrylamides; vinylpyrrolidones; and (meth)acrylic acid. Also usable are polyfunctional (meth)acrylates such as ethylene glycol di(meth)acrylate, polyethylene glycol di(meth)acrylate, trimethylolpropane tri(meth)acrylate, and pentaerythritol tetra(meth)acrylate; and polyfunctional olefins such as divinylbenzene.

The polymer may be random polymer, graft polymer, block polymer, and hydrogel, although not particularly limited thereto. In whatever form the polymer may be, the characteristic features of the present invention, i.e., the moderate reactivity and hydrophilicity due to the tertiary hydroxyl group, are not lost. The proportion of the monomers is suitably selected depending on the intended use of the polymer. To ensure the effect of the tertiary hydroxyl group, the monomer of Formula 1 is preferably used in an amount of 5 to 100 mol % based on the total monomers. The polymer may be molded or formed into a shaped article or dissolved in a solvent for use as a paint for improving the surface of an article. Also, the polymer may be blended with a known resin.

The polymer of the present invention may be produced by bulk polymerization by using only the monomers mentioned above and an polymerization initiator, or by solution polymerization, suspension polymerization or emulsion polymerization using an appropriate solvent. Examples of the solvent include alcohols such as methanol, ethanol and isopropyl alcohol; and organic solvents such as THF, DMF, dimethylsulfoxide, toluene and acetone. These solvents may be used alone or in combination of two or more in any proportion. If desired, a chain transfer agent can be used. In addition, an additive such as antioxidants, ultraviolet absorbers, lubricants, fluidity modifiers, releasing agents, antistatic agents and light diffusers; or an inorganic filler such as glass fibers, carbon fibers and clay compounds may be suitably added, if desired.

The polymer of the present invention is first characterized by simultaneously having a moderate reactivity and a moderate hydrophilicity because of the presence of a tertiary hydroxyl group. Another distinctive characteristic is the absence of an ester linkage derived from a tertiary hydroxyl group. The polymers having a tertiary hydroxyl group which are presently known in the art are synthesized from a pinacol derivative or a hydroxyadamantane derivative to be bonded through an ester linkage derived from a tertiary hydroxyl group. With such a structure, the known polymers release a polyhydric alcohol by heating. This elimination of polyhydric alcohol becomes dominant when the temperature is elevated to 180° C. or higher. Since a resin is molded or formed at over 180° C. in most cases, the elimination of polyhydric alcohol sometimes causes problems such as deterioration of mechanical strength, serious discoloration and molding defect. In contrast, the above problems can be avoided in the polymer produced from the monomer of the present invention because no ester linkage derived from a tertiary hydroxyl group is present therein.

Since the polymer of the present invention is a functional resin having a moderate reactivity and hydrophilicity, the polymer is used in various applications such as various shaped articles, films, sheets, fibers, pressure-sensitive adhesives, adhesives, paints, artificial marbles, light-guiding plates, optical fibers, foamed articles including shock absorbers and food trays, medical materials including contact lenses, artificial blood vessels, catheter, membranes for blood lavage and dental materials, supports for microorganism, fungus body and pharmacological substances, microcapsules, cosmetic base materials, inks, agents for fiber treatment, agents for paper treatments, agents for wood treatment, materials for reverse osmosis membrane, and various binder resins, although not limited thereto. Various molding aids such as fillers, colorants, reinforcing materials, waxes, thermoplastic polymers and oligomers can be added during the molding or forming process.

Like a known poly(2-hydroxyethyl methacrylate), the polymer of the present invention is suitable for use as a hydrogel in which the polymer retains water therein. The hydrogel is prepared by a known method. The water content largely depends on the type and the content of comonomer, and can be regulated within a desired range. A hydrogel having a water content of 10 to 90% by weight is most generally used in wide applications such as contact lenses, supports for fungus body, microorganisms and pharmacological substances, metal collectors, and cosmetic base materials.

The polymer of the present invention has a moderate hydrophilicity, and therefore, provides a surface excellent in biocompatibility when the surface that contacts living body or blood directly is constituted by the polymer. Regarding the blood compatibility, it has been recognized that a material becomes more antithrombotic with the increase of hydrophobicity because a hydrophobic material such as silicone hardly forms thrombus. It has been afterward found that the interfacial energy between a surface and blood is reduced by grafting hydrophilic polymer chains to the surface, thereby decreasing the interaction of the surface with proteins or cells. Thus, a hydrophilic surface also prevents the adhesion of thrombus. However, in some cases, a hydrophilic surface causes minute thrombus to form embolism, damages circulating platelet, causes calcium ion deposit, or triggers the formation of thrombus.

Therefore, it is important for a medical material to be suitably balanced in hydrophilicity, hydrophobicity and biocompatibility. It is generally acknowledged that a surface having a static contact angle of 30 to 70° with 25° C. water is excellent in biocompatibility. The polymer produced from the monomer of the present invention is useful because the static contact angel with 25° C. water is 30 to 80°. In addition, since the polymer of the present invention is less soluble to water as compared with a known typical hydrophilic polymer, poly(2-hydroxyethyl (meth)acrylate), the polymer is hardly dissolved into a contact aqueous medium, hardly spoils the surface appearance and hardly reduces the mechanical strength.

The polymer of the present invention has a moderate reactivity. Therefore, if it is used as a polyol component of various types of paints, particularly as a polyol component of an isocyanate hardening paint, the pot life of the paint can be controlled to a desired level by suitably adjusting the content of the tertiary hydroxyl group. Since the rate of hardening reaction can be also controlled, the surface of paint coating can be made smooth. Although not particularly limited, the polymer for use as a polyol component of paints generally has a number average molecular weight of 1000 to 100000 when calibrated by polystyrene standard and a hydroxyl value of 50 to 300 mgKOH/g. The use of a polymer having a content of tertiary hydroxyl group to the total hydroxyl group of 5 to 100 mol % is preferred because the prolongation effect for pot life and the surface smoothing effect due to the reactivity of tertiary hydroxyl group are enhanced.

The present invention will be explained in more detail by reference to the following example which should not be construed to limit the scope of the present invention.

### (I) Synthesis of Vinyl-Polymerizable Monomer

### EXAMPLE 1

Into a 1000-mL reactor equipped with a stirrer, a fractionating condenser, a thermometer and a gas inlet, were charged 500 g of methyl methacrylate (MMA), 222 g of 2-methyl-1,2-propanediol, 3.6 g of sodium methoxide and 0.72 g of hydroquinone. By blowing air into the mixture at 20 mL/min, the reaction was allowed to proceed at 80 to 100° C. for 6 h while distilling away the generated methanol. The removal of methanol was continued at 200 to 150 mmHg for 8 h, and then the pressure was further reduced gradually to remove methanol and the unreacted methyl methacrylate by distillation.

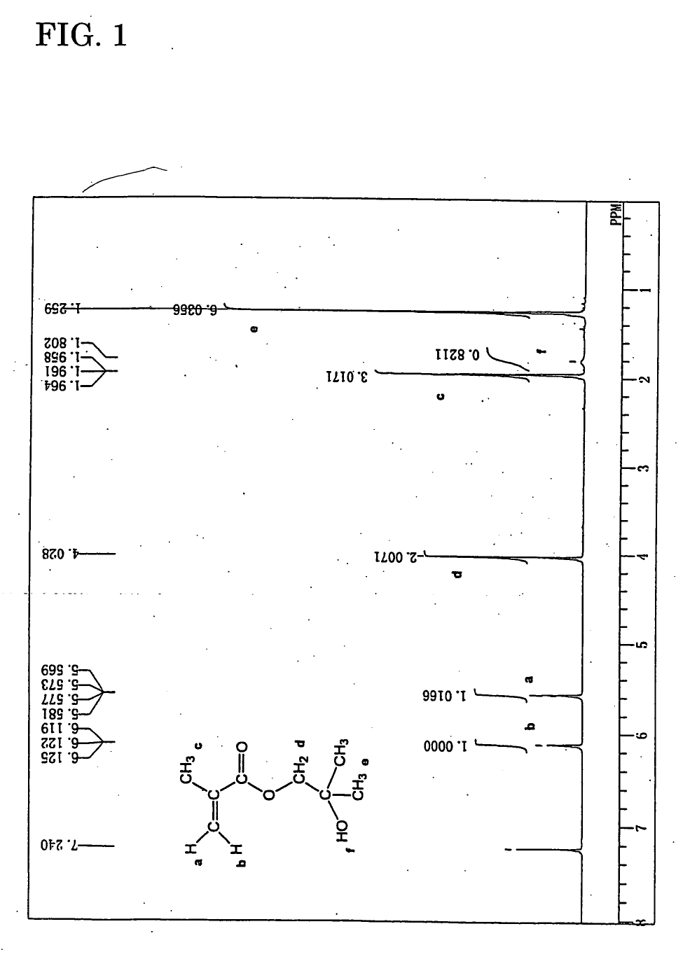

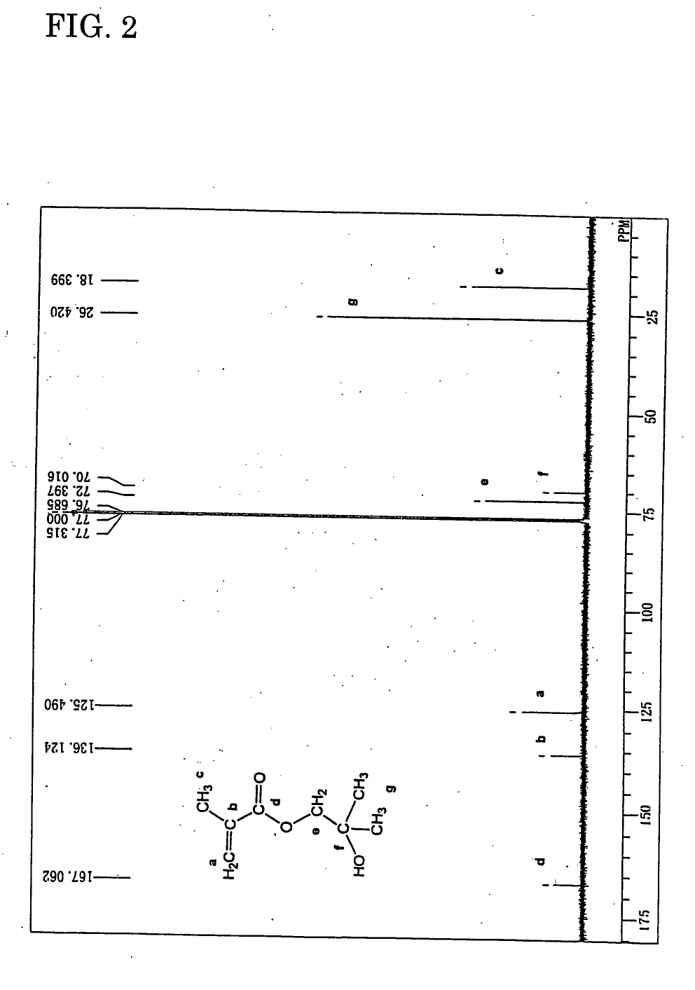

The liquid residue was rectified under reduced pressure to obtain 375 g of a colorless transparent liquid. By GC-MAS (gas chromatography-mass spectrometry), ¹H-NMR and ¹³C-NMR, the product was identified as 2-hydroxy-2-methylpropyl methacrylate. ¹H-NMR spectra and ¹³C-NMR spectra are respectively shown in FIGS. 1 and 2 together with assignment of peaks.

### EXAMPLE 2

Into a 500-mL reactor equipped with a stirrer, a fractionating condenser, a thermometer and a gas inlet, were charged 172 g of methacrylic acid, 180 g of IBG, 1.76 g of zinc chloride and 0.35 g of 2,6-di-tert-butyl-p-cresol. By blowing air into the mixture at 20 mL/min, the reaction was allowed to proceed at 80 to 100° C. for 6 h while distilling away the generated water. The removal of water was continued at 200 to 150 mmHg for 5 h, and then the pressure was further reduce gradually to further remove water by distillation.

To the liquid residue, 3.52 g of a catalyst adsorbent (Mizuka Life P-1 manufactured by Mizusawa Kagaku Kogyo Co., Ltd.). The mixture was stirred for 30 min, cooled to room temperature, and filtered to obtain 200 g of 2-hydroxy-2-methylpropyl methacrylate as a colorless transparent liquid.

### EXAMPLE 3

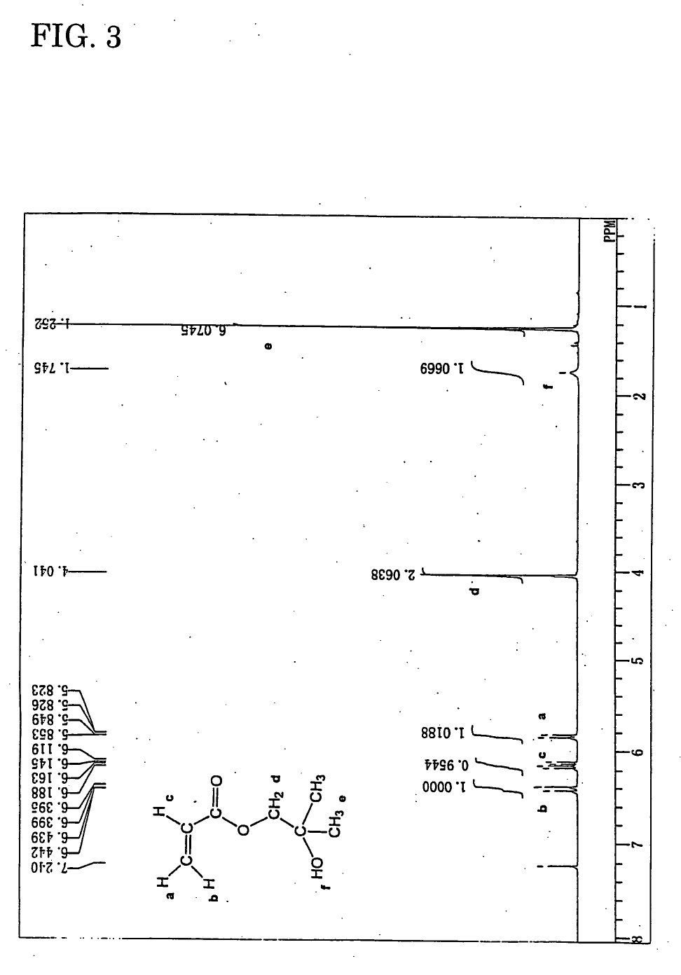

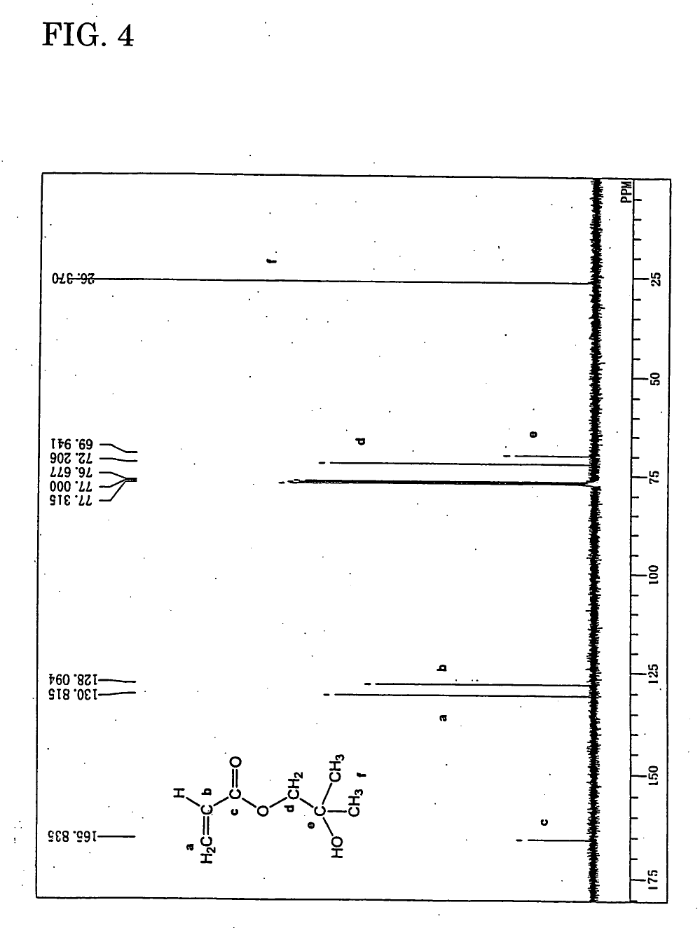

Into a 500-mL reactor equipped with a stirrer and a thermometer, were charged 59.1 g of 2-methyl-2,4-pentanediol, 52.3 g of triethylamine and 150 mL of methylene chloride. The mixture was kept at 15° C. under stirring in a water bath. Then, 56.0 g of methacryloyl chloride was added dropwise over 15 min and then the stirring was continued for 8 h at 15 to 25° C. After the reaction was completed, the reaction liquid was separated into aqueous layer and organic layer by adding water. The organic layer was sequentially washed with a 5% aqueous sodium hydroxide solution, a 5% hydrochloric acid, and water. After drying the organic layer over anhydrous magnesium sulfate, the solvent was removed by distillation under reduced pressure to obtain 75.7 g of a colorless transparent liquid, which was then purified by a column chromatography. By GC-MAS, ¹H-NMR and ¹³C-NMR, the product was identified as 3-hydroxy-1,3-dimethylbutyl methacrylate. ¹H-NMR spectra and ¹³C-NMR spectra are respectively shown in FIGS. 3 and 4 together with assignment of peaks.

### EXAMPLE 4

Into a 500-mL flask equipped with a thermometer, a stirrer, a reflux condenser and a dropping funnel, were charged 172 g of methacrylic acid, 0.24 g of Antage W-400 (product of Kawaguchi Kagaku Kogyo Co., Ltd.) and 2.4 g of iron(III) hydroxide. The mixture was stirred at 50° C. under heating while blowing air at 10 mL/min. From the dropping funnel, 144 g of isobutylene oxide was gradually added dropwise to the flask over 2 h. The stirring was further continued for 5 h at 60° C. under heating. The gas chromatographic analysis of the reaction liquid showed that the conversion of isobutylene oxide was 95% and the selectivity of 2-hydroxy-2-methylpropyl methacrylate was 90%. After the reaction was completed, the reaction liquid was subjected to phase separation by adding 158 g of cyclohexane and 32 g of a 2 wt % aqueous sodium carbonate to extract the target compound into the organic layer and extract the catalyst and the unreacted methacrylic acid into water layer. By removing the cyclohexane solvent under reduced pressure, 2-hydroxy-2-methylpropyl methacrylate was isolated.

### EXAMPLE 5

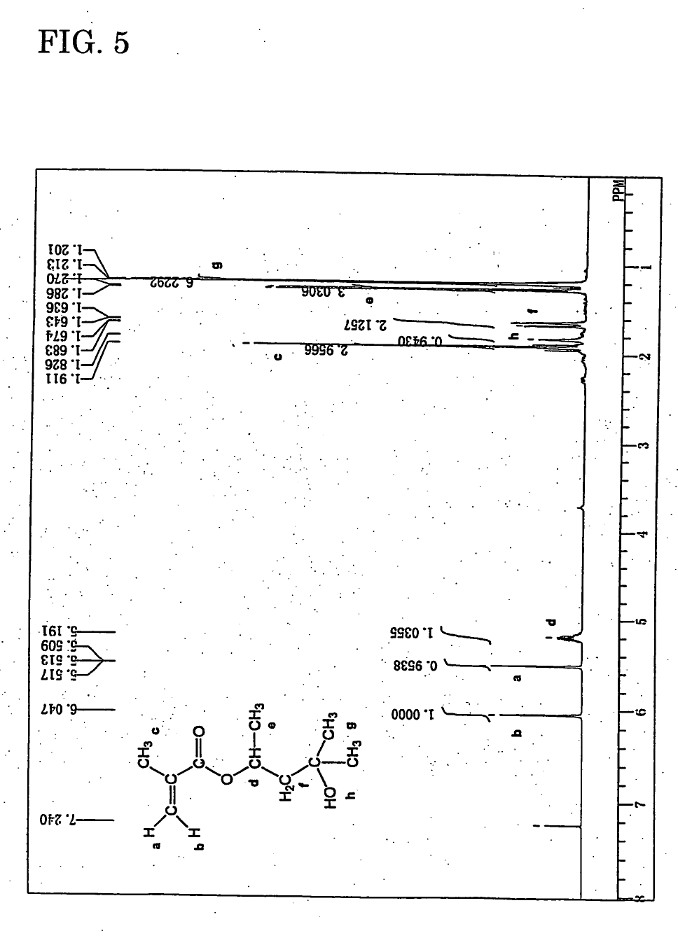

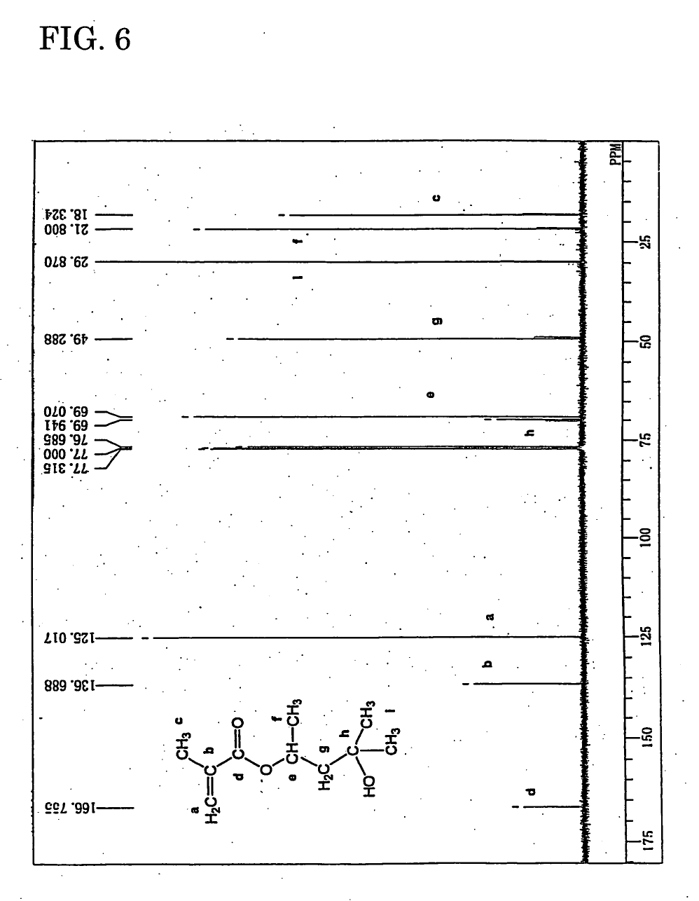

The procedure of Example 1 was repeated except for using 430 g of methyl acrylate in place of 500 g of MMA. By GC-MAS, ¹H-NMR and ¹³C-NMR, the product was identified as 2-hydroxy-2-methylpropyl acrylate. ¹H-NMR spectra and ¹³C-NMR spectra are respectively shown in FIGS. 5 and 6 together with assignment of peaks.

### EXAMPLE 6

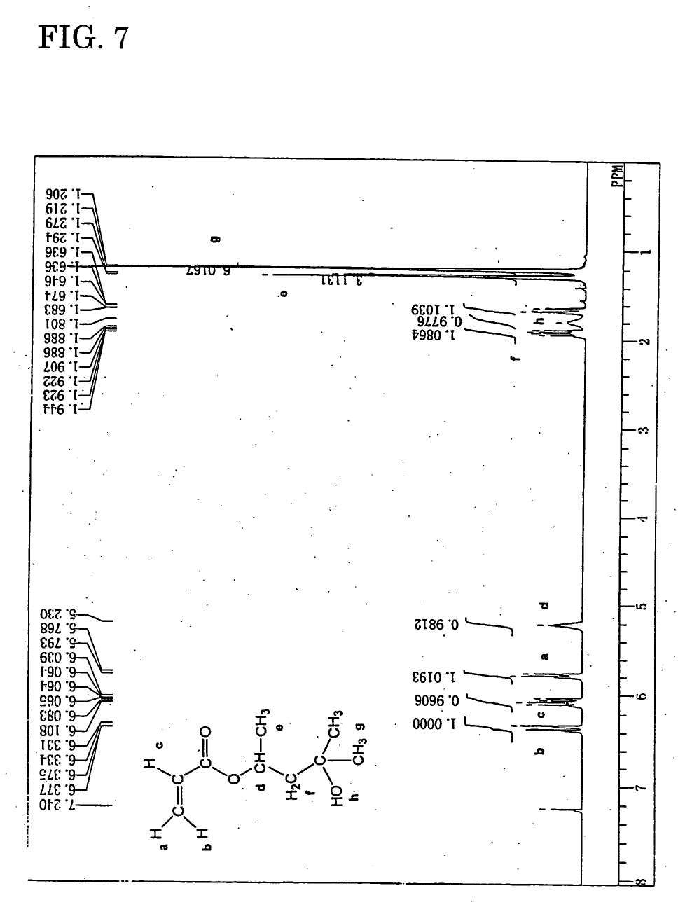

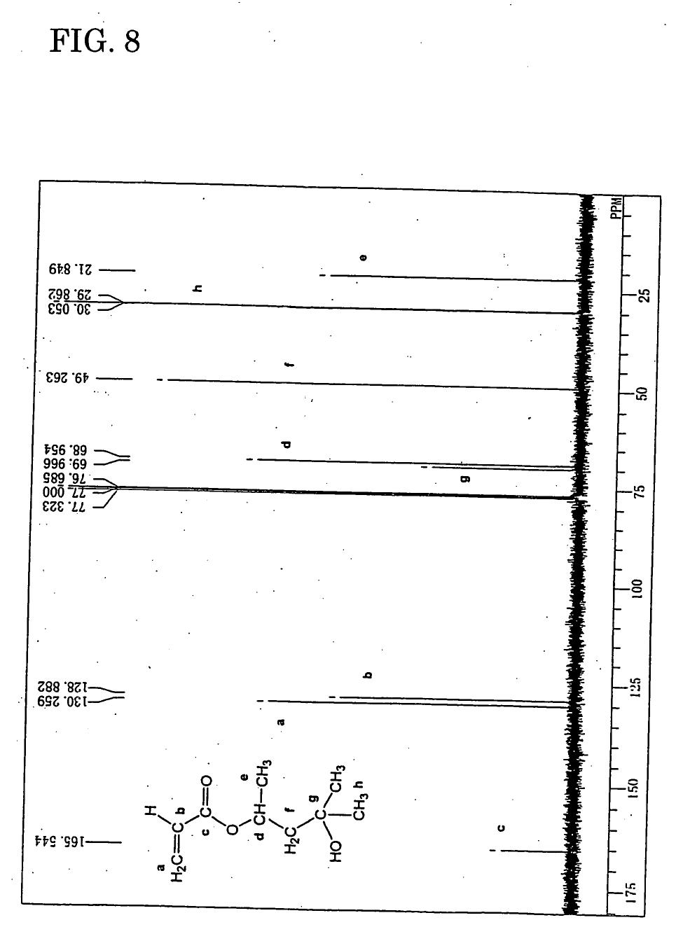

The procedure of Example 3 was repeated except for using 48.5 g of acryloyl chloride in place of 56 g of methacryloyl chloride. The reaction product was purified by a column chromatography. By GC-MAS, ¹H-NMR and ¹³C-NMR, the product was identified as 3-hydroxy-1,3-dimethylbutyl acrylate. ¹H-NMR spectra and ¹³C-NMR spectra are respectively shown in FIGS. 7 and 8 together with assignment of peaks.

### EXAMPLE 7

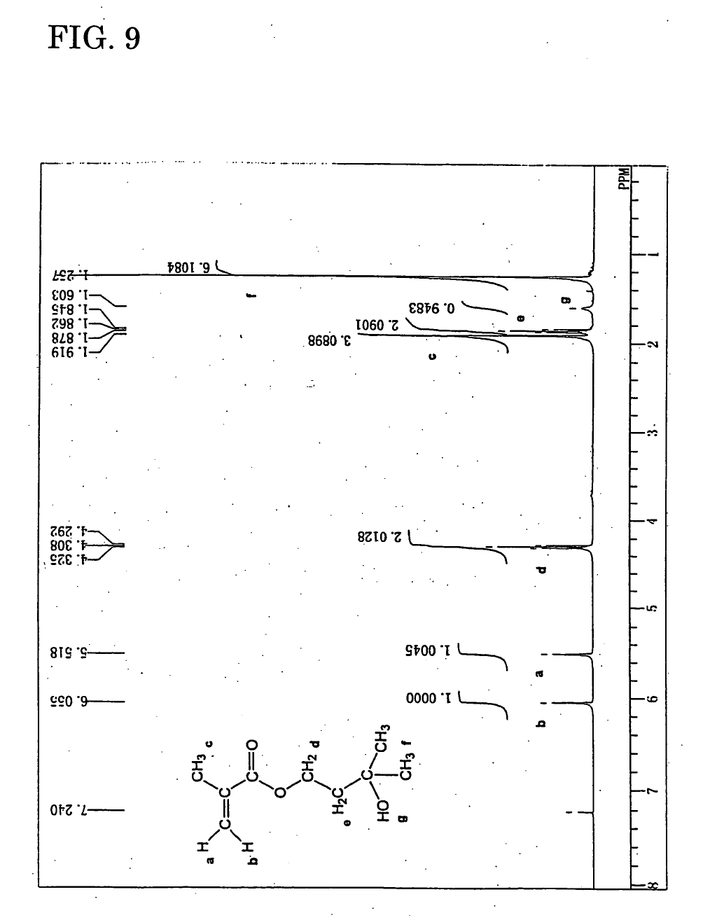

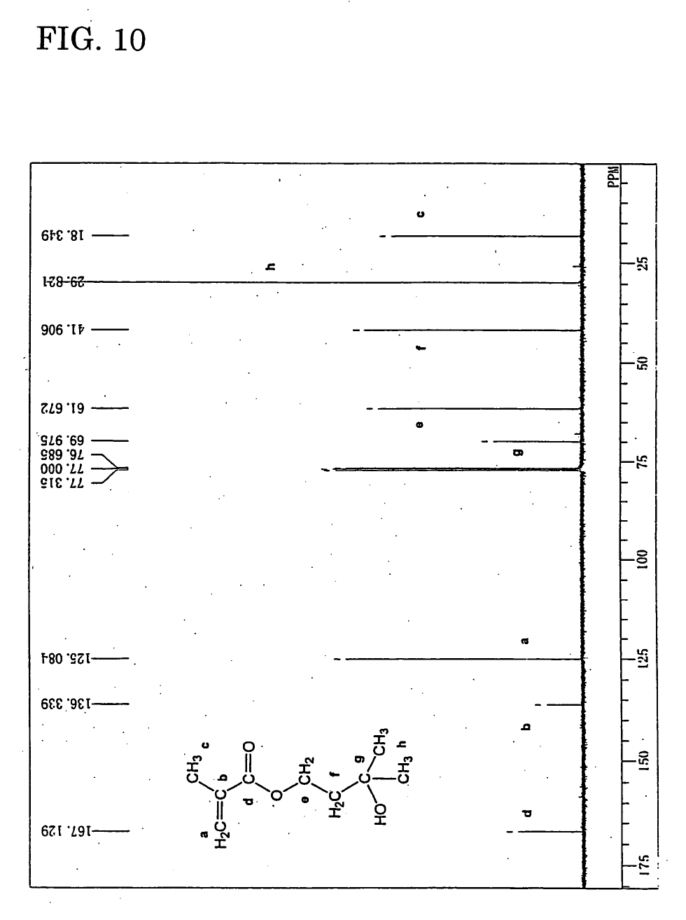

The procedure of Example 1 was repeated except for using 257 g of 3-methyl-1,3-butanediol in place of 222 g of IBG. By GC-MAS,¹H-NMR and ¹³C-NMR, the product was identified as 3-hydroxy-3-methylbutyl methacrylate. ¹H-NMR spectra and ¹³C-NMR spectra are respectively shown in FIGS. 9 and 10 together with assignment of peaks.

### EXAMPLE 8

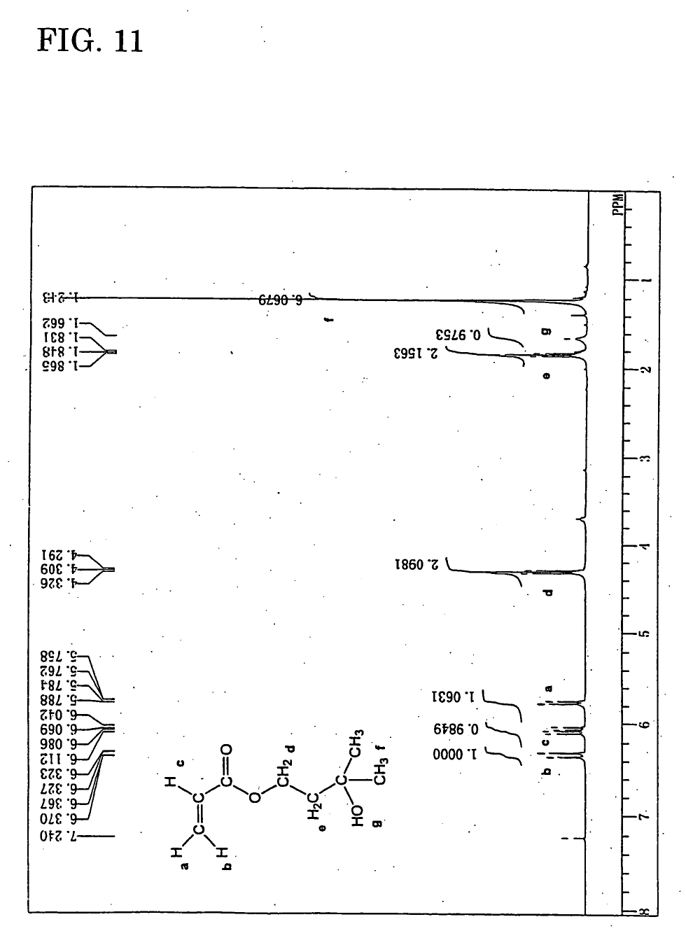

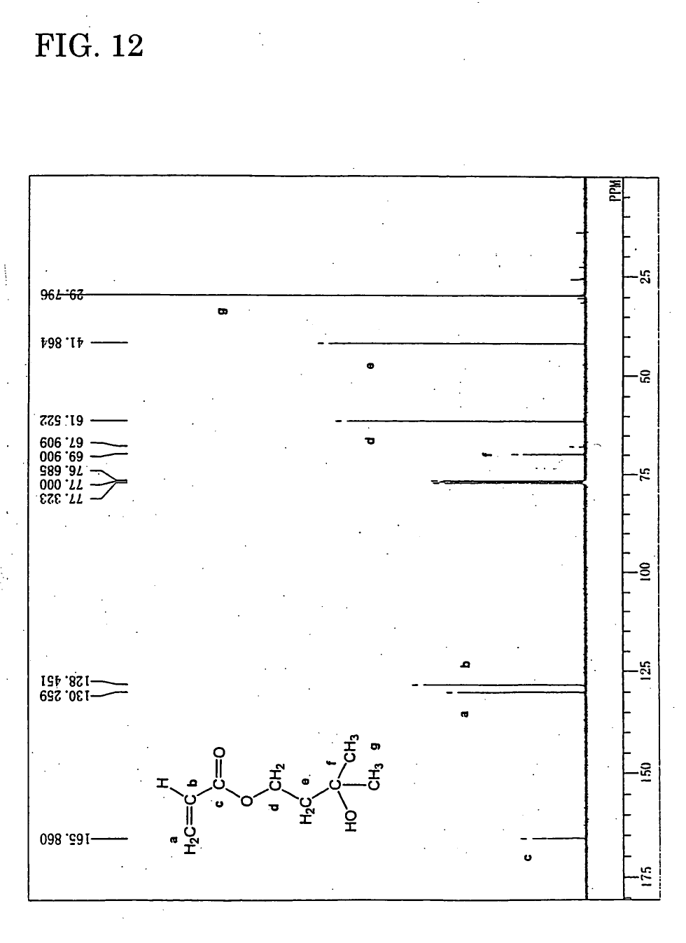

The procedure of Example 1 was repeated except for using 257 g of 3-methyl-1,3-butanediol in place of 222 g of IBG, and 430 g of methyl acrylate in place of 500 g of MMA. By GC-MAS, ¹H-NMR and ¹³C-NMR, the product was identified as 3-hydroxy-3-methylbutyl acrylate. ¹H-NMR spectra and ¹³C-NMR spectra are respectively shown in FIGS. 11 and 12 together with assignment of peaks.

### (II) Polymer of Vinyl-Polymerizable Monomer Having Tertiary Hydroxyl Group

### EXAMPLE 9

Into a 200-mL glass reactor equipped with a stirrer, a condenser and a thermometer, were charged 60 g of 2-hydroxy-2-methylpropyl methacrylate (HBMA) as a monomer, 0.12 g of dodecanethiol (DSH) as a chain transfer, 0.3 g of 2,2′-azobis(2-methylbutyronitrile) (ABN-E) as a polymerization initiator, and 60 g of methanol as a solvent. The polymerization was allowed to proceed at 65° C. for 3 h under stirring. The polymerization liquid was dropped into diisopropyl ether to precipitate the polymer, which was then vacuum-dried. The polymerization proceeded uniformly, and the polymer thus obtained completely dissolved in an organic solvent such as methanol, acetone and THF.

The yield of the polymer was determined gravimetrically. The molecular weight was determined by a gel permeation chromatography (GPC) using THF as the developing solvent while calibrated by polystyrene standard. The contact angle as an index of hydrophilicity of the polymer was measured by a contact angle analyzer (CA-X Model manufactured by Kyowa Kaimen Kagaku Co., Ltd.). The sample was prepared by casting a polymer solution in ethanol/THF mixed solvent on a glass plate and then drying. The results are shown in Table 1.

### EXAMPLE 10

Polymer was prepared in the same manner as in Example 9 except for using a monomer mixture of 39.5 g of HBMA and 25 g of MMA. The results are shown in Table 1.

### EXAMPLE 11

Polymer was prepared in the same manner as in Example 9 except for using a monomer mixture of 25 g of HBMA and 37 g of MMA. The results are shown in Table 1.

### EXAMPLE 12

Polymer was prepared in the same manner as in Example 9 except for using a monomer mixture of 8.8 g of HBMA and 50 g of MMA. The results are shown in Table 1.

### EXAMPLE 13

Polymer was prepared in the same manner as in Example 9 except for using a monomer mixture of 4.5 g of HBMA and 54 g of MMA. The results are shown in Table 1.

### COMPARATIVE EXAMPLE 1

Polymer was prepared in the same manner as in Example 9 except for using 50 g of MMA as the monomer and toluene as the solvent. The results are shown in Table 1.

### COMPARATIVE EXAMPLE 2

Polymer was prepared in the same manner as in Example 9 except for using 50 g of 2-hydroxyethyl methacrylate (HEMA) as the monomer. The results are shown in Table 1.

### COMPARATIVE EXAMPLE 3

Polymer was prepared in the same manner as in Example 9 except for using a monomer mixture of 32.5 g of HEMA and 25 g of MMA. The results are shown in Table 1.

### COMPARATIVE EXAMPLE 4

Polymer was prepared in the same manner as in Example 9 except for using a monomer mixture of 21 g of HEMA and 37.7 g of MMA. The results are shown in Table 1.

### COMPARATIVE EXAMPLE 5

Polymer was prepared in the same manner as in Example 9 except for using a monomer mixture of 7.5 g of HEMA and 52 g of MMA. The results are shown in Table 1.

TABLE 1

| | Examples | | | | |
|---|---|---|---|---|---|
| | 9 | 10 | 11 | 12 | 13 |
| Ratio of charged monomers (mol %) | | | | | |
| MMA | 0 | 50 | 70 | 90 | 95 |
| HBMA | 100 | 50 | 30 | 10 | 5 |
| Yield (wt %) | 78 | 72 | 48 | 55 | 68 |
| Molecular weight (×10000) | 15 | 10 | 12 | 10 | 10 |
| Contact angle (°) | 60 | 62 | 65 | 67 | 69 |
| | Comparative Examples | | | | |
| | 1 | 2 | 3 | 4 | 5 |
| Ratio of charged monomers (mol %) | | | | | |
| MMA | 100 | 0 | 50 | 70 | 90 |
| HBMA | 0 | 100 | 50 | 30 | 10 |
| Yield (wt %) | 67 | 77 | 56 | 53 | 62 |
| Molecular weight (×10000) | 10 | —* | 6.1 | 10 | 9.0 |
| Contact angle (°) | 72 | 60 | 61 | 65 | 68 |

*not measured because not soluble in THF.

### (III) Preparation of Hydrogel

### EXAMPLE 14

A uniform mixture of 8.3 g of HBMA and 0.5 g of ethylene glycol dimethacrylate (EGDMA) was added with 0.1 g of ABN-E. The resultant mixture was placed into a polypropylene tubular container with 20 mm inner diameter.

After deaerating under reduced pressure, the polymerization was allowed to proceed for 4 h in a 40° C. water tank. The polymerization was further continued for 4 h at 50° C., for 4 h at 60° C. under heating, and then the temperature was gradually raised in a dryer from 60° C. up to 130° C. over 12 h, thereby obtaining a rod-shape polymer with about 20 mm diameter.

The rod-shape polymer was cut into a test specimen. The weight (W₀ g) of the test specimen in equilibrium condition on water-absorbing and the weight (W₁ g) of a dried test specimen were measured to calculate the water content (wt %) from the following equation:

Water content (wt %)=[(W₀−W₁)/W₀]×100.

The result is shown in Table 2.

### EXAMPLES 15 to 18 and COMPARATIVE EXAMPLES 6 to 10

Each rod-shape polymer was prepared in the same manner as in Example 14 except for changing the molar ratio of the methacrylate mixture as shown in Table 2. The water content of each test specimen prepared in the same manner is shown in Table 2.

TABLE 2

| | Examples | | | | |
|---|---|---|---|---|---|
| | 14 | 15 | 16 | 17 | 18 |
| Ratio of charged methacrylates (mol %) | | | | | |
| MMA | 0 | 49 | 0 | 0 | 0 |
| HEMA | 0 | 0 | 49 | 69 | 89 |
| HBMA | 99 | 50 | 50 | 30 | 10 |
| EGDMA | 1 | 1 | 1 | 1 | 1 |
| Water content (wt %) | 26 | 12 | 32 | 34 | 37 |
| | Comparative Examples | | | | |
| | 6 | 7 | 8 | 9 | 10 |
| Ratio of charged methacrylates (mol %) | | | | | |
| MMA | 0 | 49 | 69 | 10 | 99 |
| HEMA | 99 | 50 | 30 | 89 | 0 |
| HBMA | 0 | 0 | 0 | 0 | 0 |
| EGDMA | 1 | 1 | 1 | 1 | 1 |
| Water content (wt %) | 39 | 19 | 10 | 35 | 2 |

### (TV) Synthesis of Coating Resin Having Tertiary Hydroxyl Group

### EXAMPLE 19

Into a 5000-mL reactor equipped with a stirrer, a condenser and a thermometer, were charged 1600 g of xylene and 400 g of butyl acetate. After raising the temperature to 85° C., the polymerization was allowed to proceed by adding dropwise over 3 h a mixture of 500 g of styrene, 500 g of methyl methacrylate, 280 g of n-butyl acrylate, 420 g of n-butyl methacrylate, 86 g of 2-hydroxy-2-methylpropyl methacrylate, 168 g of 2-hydroxyethyl methacrylate, 14 g of acrylic acid, and 24 g of α,α′-azobisisobutyronitrile. After the dropwise addition, the stirring was continued for 2 h under heating. The stirring was further continued for 3 h under heating by adding 10 g of α,α′-azobisisobutyronitrile. By evaporating off the solvent, was obtained 1830 g of a coating resin A having a hydroxyl value of 52 mgKOH/g and an acid value of 6 mgKOH/g.

A varnish A was prepared by blending 75 parts by weight of the coating resin A and 25 parts by weight of toluene.

### COMPARATIVE EXAMPLE 11

A coating resin B (1770 g) having a hydroxyl value of 52 mgKOH/g and an acid value of 5 mgKOH/g was prepared in the same manner as in Example 19 except for changing the mixture of monomers and polymerization initiator being added dropwise to a mixture of 500 g of styrene, 400 g of methyl methacrylate, 380 g of n-butyl acrylate, 420 g of n-butyl methacrylate, 240 g of 2-hydroxyethyl methacrylate, 14 g of acrylic acid, and 24 g of α,α′-azobisisobutyronitrile.

A varnish B was prepared by blending 75 parts by weight of the coating resin B and 25 parts by weight of toluene.

Each enamel paint was prepared by blending the ingredients in the proportions shown in Table 3. Specifically, a rutile titanium dioxide pigment (CR-90, product of Ishihara Sangyo Co., Ltd.) was dispersed in the varnish A or B. The dispersion was further added with a hardening agent (DN-980, product of Dainippon Ink & Chemicals, Inc.) and a leveling agent (BYK-301, product of BYK-chemie Japan Co., Ltd.) to prepare an enamel paint. The enamel paint was coated by a doctor blade on a chemically treated steel plate in a thickness of 15 to 20 μm. The results of evaluation on the coating film are shown in Table 3.

TABLE 3

| | | Comparative |
|---|---|---|
| | Example 19 | Example 11 |
| Composition of paint (part by weight) | | |
| Varnish type | A | B |
| amount | 57.2 | 57.2 |
| CR-90 | 31.3 | 31.3 |
| DN-980 | 11.0 | 11.0 |
| BYK-30 | 0.5 | 0.5 |
| Pot life (h) | 1.0 | 0.3 |
| 60° Specular gloss (%) | 92 | 92 |
| Erichsen value (mm) | >7 | >7 |
| Pencil hardness | H | H |
| Rubbing test | good | good |

The evaluations were made as follows.

Hydroxyl value: Measured according to JIS K-0070.

Acid value: Measure according to JIS K-8400.

Pot life: Time taken after the solution containing a coating resin was mixed with a hardening agent until the viscosity reached twice the initial viscosity was measured.

60° Specular gloss: Measured according to JIS K-5400.

Erichsen value: Measured according to JIS K-5400.

Pencil hardness: Measured according to JIS K-5400.

Rubbing test: After rubbing 100 times the surface of paint film with gauze impregnated with toluene, the surface was visually observed. The result was rated as “good” when no change was noticed, and “poor” when the paint film was partially dissolved.

As seen from the results, by using the tertiary hydroxyl group-containing monomer of the present invention as a starting material for varnish, the pot life, as compared with using known monomers, is prolonged three times or more with the paint film performance retained.

In the present invention, the novel vinyl-polymerizable monomer of Formula 1 having a vinyl-polymerizable group X and a tertiary hydroxyl group is prepared by the reaction of a compound for introducing the vinyl-polymerizable group X and a compound for introducing the tertiary hydroxyl group. With a moderate hydrophilicity and reactivity of the monomer, a polymer produced by the copolymerization of the monomer and other vinyl comonomers is used in various applications such as various shaped articles, films, sheets, fibers, pressure-sensitive adhesives, adhesives, paints, artificial marbles, light-guiding plates, optical fibers, foamed articles including shock absorbers and food trays, medical materials including contact lenses, artificial blood vessels, catheter, membranes for blood lavage and dental materials, supports for microorganism, fungus body and pharmacological substances, microcapsules, cosmetic base materials, inks, agents for fiber treatment, agents for paper treatments, agents for wood treatment, materials for reverse osmosis membrane, and various binder resins.

What is claimed is:

1. A polymer having a tertiary hydroxyl group, which is produced by polymerizing a first monomer component of at least one vinyl-polymerizable monomer and a second monomer component of at least one vinyl comonomer other than the at least one vinyl-polymerizable monomer, the first monomer component being 5 to 100 mol % and the second monomer component being 0 to 95 mol % each being based on a total of the first monomer component and the second monomer component, wherein a number average molecular weight calibrated by polystyrene standard is 1000 to 100,000, a hydroxyl value is 50 to 300 mgKOH/g, and a first monomer component is represented by the following Formula 1: 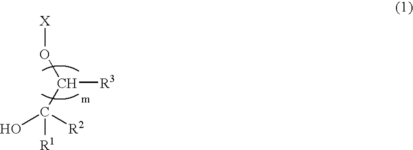
wherein X is a vinyl-polymerizable functional group; R¹ and R² may be the same or different and each is an alkyl group having 1 to 4 carbon atoms; R³ is methyl or hydrogen; and m is an integer of 1 to 3, with the proviso that two or three R³ groups when m is 2 or 3 are the same or different from each other.

2. The polymer according to claim 1, wherein 5 to 100 mol % of repeating units is a unit derived fro the first monomer component, and 0 to 95 mol % of the repeating units is a unit derived from the second monomer component.

3. The polymer according to claim 1, wherein no polyhydric alcohol having a tertiary hydroxyl group is eliminated from the polymer at 180° C.

4. The polymer according to claim 1, wherein a ratio of the tertiary hydroxyl group to total hydroxyl groups is 5 to 100 mol %.

5. The polymer according to claim 1, which is in the form of hydrogel.

6. The polymer according to claim 5, wherein a water content of the hydrogel is 10 to 90% by weight.

7. The polymer according to claim 1, wherein the at least one vinyl-polymerizable monomer includes 2-hydroxy-2-methylpropyl(meth)acrylate represented by the following Formula 3: 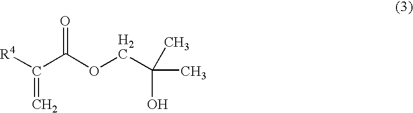
wherein R⁴ is methyl or hydrogen.

8. The polymer according to claim 1, wherein said second monomer component is at least one selected from the group consisting of unsaturated carboxylic acids and esters thereof, styrene, styrene derivatives, conjugated vinyl compounds and α-olefins.

9. The polymer according to claim 1, in a form selected from the group consisting of random polymer, graft polymer and block polymer.

10. The polymer according to claim 1, which does not contain an ester linkage derived from a tertiary hydroxyl group.

11. The polymer according to claim 1, having a static contact angle, with 25° C. water, of 30° to 80°.
